(19) United States
(12) Patent Application Publication
(10) Pub. No.: US 2022/0342372 A1
(43) Pub. Date: Oct. 27, 2022

(54) Method for Generating Self-Description Data Modules

(71) Applicant: Siemens Aktiengesellschaft, Muenchen (DE)

(72) Inventors: Brent HANNIMAN, Nürnberg (DE); Steffen LAMPARTER, Feldkirchen (DE); Jens MECKEL, Postbauer-Heng (DE); Jörg NEIDIG, Nürnberg (DE)

(21) Appl. No.: 17/762,786

(22) PCT Filed: Sep. 24, 2019
(86) PCT No.: PCT/EP2019/075598

§ 371 Date: Mar. 23, 2022

(51) Int. Cl. G05B 19/042

(52) U.S. Cl. CPC G05B 19/042; G05B 2219/25418

(57) ABSTRACT

A method for generating respective self-description data modules with respect to at least one functionality and/or at least one component, device, or system, wherein a data collection is provided comprising engineering elements from at least one of the three data sources, where relationship information is ascertained in which each piece of relationship information is assigned to engineering elements of the data collection, a multigraph comprising nodes and connections between nodes is generated, a clustering method is applied to the multigraph to ascertain at least one sub-graph within the multigraph, a sub-graph is selected from the ascertained at least one sub-graph, and a self-description data module relating to a component and/or a functionality of the device or system is generated.

### CROSS-REFERENCE TO RELATED APPLICATIONS

This is a U.S. national stage of application No. PCT/EP2019/075598 filed 24 Sep. 2019.

### BACKGROUND OF THE INVENTION

### 1. Field of the Invention

The present invention relates to a method for generating a self-description data module in relation to at least one functionality and/or at least one component of a device or installation.

### 2. Description of the Related Art

Self-description data modules are generally known from the prior art.

By way of example, US 2019/0025785 A1 l discloses a module for an installation, where the module executes a technical sub-process of the installation. The module comprises an external interface for publishing at least one service that the module may make available to a particular product. In this case, the interface likewise comprises information about the technical hardware and the functional scope of this module along with dynamic information regarding temporally changed data within the module that may arise for example in the course of controlling the module. Said US 2019/0025785 A1 furthermore discloses that the abovementioned information may be made available for example in the form of a “module type package” (MTP).

One disadvantage of the cited prior art is that in particular the compilation of such static information in relation to a functionality of an item of hardware and further hardware properties may often be correspondingly complex, because such data often originate from different data sources.

### SUMMARY OF THE INVENTION

In view of the foregoing, it is therefore an object of the present invention to provide a method that makes it possible, in a simplified manner, to collect and to compile information about a technical item of hardware from different sources.

This and other objects and advantages are achieved in accordance with the invention by a method which is configured to generate a self-description data module in relation to at least one functionality and/or at least one component of a device or installation, where a data collection comprising engineering elements from at least one of the three data sources listed below is present:
a first data source containing automation engineering data in relation to automation and/or an automation plan of the installation or device or parts thereof,
a second data source containing MCAD data in relation to a mechanical and/or spatial plan of the device or installation or parts thereof, and/or in relation to a mechanical and/or spatial design of the device or installation or parts thereof,
a third data source containing electronic computer aided design (ECAD) data in relation to an electrical plan and/or circuit diagram of the device or installation or parts thereof, and/or in relation to an electrical design and/or implemented circuit diagram of the device or installation or parts thereof. The method comprises a.) ascertaining relationship information respectively associated with engineering elements of the data collection, b.) generating a multigraph comprising nodes and connections between nodes, where the nodes are each associated with engineering elements of the data collection and the connections between nodes are each associated with relationship information ascertained in accordance with method step a.), c.) applying a clustering method to the multigraph in order to ascertain at least one sub-graph within the multigraph, d.) selecting a sub-graph from the at least one sub-graph ascertained in method step c.), and e.) creating a self-description data module in relation to a component and/or a functionality of the device or installation, where the self-description data module comprises the selected sub-graph and/or information contained in the sub-graph.

Such a method for generating a self-description data module may, for example, execute in an automated manner or else in a partially automated manner.

The sequence of method steps d.) and e.) in accordance with the present disclosure may also, for example, be executed multiple times in succession, such that, in succession, a respective sub-graph is selected, where the associated self-description data module comprising this sub-graph is generated and a further sub-graph is then subsequently selected again in order to then again also generate a self-description data module therefor, etc.

The data collection may in this case comprise a compilation of the engineering elements contained therein, in particular including any meta-information associated with the engineering elements. This compilation of the engineering elements within the data collection may in this case be configured as a table or a comparable compilation. The table may in this case, for example, contain engineering elements themselves, and/or also names or designations for engineering elements.

The wording whereby engineering elements including any meta-information associated therewith are contained in the data collection is understood to mean, in the context of the present disclosure and the claims, that the engineering elements including meta-information associated therewith are contained in the data collection when these engineering elements actually have associated meta-information. When engineering elements do not have any associated meta-information, engineering elements are then contained in the data collection without meta-information.

A self-description data module may, for example, be configured as a searchable data collection of information relevant to a particular functionality or component of the device or installation.

A self-description data module may furthermore be formed as a functional data module or may comprise at least functional elements. Such functional data modules or functional elements of such data modules may, for example, be established such that they are configured to execute particular functions or functionalities of the device or installation on their own. Such functional data modules or functional elements may, for example, be configured as software elements or modules (or comprise such software elements) that execute the function or functionality when they are executed.

The software elements may, for example, be engineering elements in accordance with the present disclosure, which may be configured, for example, in the form of control programs, user programs, elements of such programs, function modules, data modules and/or similar what are known as POUs (program object units) or may comprise such software modules. The software modules and/or the executable software elements may then, in one advantageous embodiment, be contained fully or at least partially in a self-description data module associated with a corresponding functionality of the device or installation or the associated sub-graph. Such software modules or executable software elements may furthermore also be contained in one of the data sources and/or the compilation of engineering elements.

Such functions or functionalities of such self-description data modules in the form of functional data elements or comprising functional data elements or software elements may, for example, be referred to as what are known as “skills”. In this case, for example, a corresponding functional data module or functional element that is associated with such a “skill” may, for example, be configured such that, following the input of input parameters and/or call commands required to execute the skill, it is configured to execute the function or functionality associated with the skill on its own. This may, for example, be configured such that the function or functionality is executed accordingly when the corresponding software elements of the corresponding self-description data module are executed, for example, by an execution environment, for example, of the device or installation.

Such skills may range, for example, from relatively simple activities such as opening a valve or reading out a sensor value up to more complex functionalities, which may consist, for example, of multiple simpler functionalities. Such more complex functionalities may, for example, be packaging a product or what is known as a “pick and place” process for gripping, moving and placing an object. Such a pick and place process or pick and place skill may, for example, comprise elementary functionalities or skills such as identifying an object, gripping an object, moving the object, identifying a setting down location and setting down the object.

In order to execute such a skill, provision may then, for example be, made for the corresponding self-description data module to be transferred with the parameters required to execute the skill, such as the description of an object to be gripped and a setting down position for it, and the skill is then executed by executing one or more corresponding functional data elements and/or software elements contained in the self-description data module. The corresponding self-description data module may furthermore comprise skill description information that contains, for example, information about the skill performed or able to be performed by the self-description data module. In this case, the skill description may comprise, for example, information about a performed functionality and the input parameters required to execute the functionality.

In the context of the present disclosure, a sub-graph linked to a particular functionality of the device or installation may, for example, be considered to be an implementation of a skill linked to this functionality. This then applies in a comparable manner to a self-description data module comprising this sub-graph.

The self-description data module may furthermore be configured to communicate the skill description information to other apparatuses, units, computers or comparable data processing units.

Such an embodiment of a self-description data module may, for example, be advantageous when using the device or installation in the context of a “plug and produce” system.

The wording “at least one of the three data sources listed below” is understood to mean, in the context of the present disclosure and the claims, that the data collection may comprise a selection of engineering elements from one, two or else all three of the three data sources. The data collection may also consist of a selection of one, two or else all three of the three data sources.

Each of the data sources may in this case comprise engineering elements from at least one corresponding data category.

The wording whereby each of the data sources comprises engineering elements from at least one corresponding data category is understood to mean, in connection with the present disclosure, that the automation engineering data comprise engineering elements from at least one data category for automation engineering data, the mechanical computer aided design (MCAD) data comprise engineering elements from at least one data category for MCAD data and the ECAD data comprise engineering elements from at least one data category for ECAD data.

The device or installation may, for example, be configured in the form of a machine, an apparatus, a robot, a production installation or the like or else comprise such parts as components. Such a device or installation may, for example, comprise one or more components, drives, sensors, machines, apparatuses, communication units or the like.

Engineering elements in the context of the present disclosure and claims are understood to mean all data, modules, software elements, graphical displays, images or comparable elements that are used or are able to be used for engineering of the device or installation using the automation engineering data, the mechanical planning data and the electrical planning data.

Respective typical types of engineering elements and corresponding engineering elements are explained by way of example below with reference to the automation engineering data, the mechanical planning data and the electrical planning data.

In this case, the engineering elements may be taken, for example, directly from the respective data sources. Furthermore, by way of example, engineering elements may also be taken from images present in the data collection and/or graphical depictions through optical pattern recognition and/or optical character recognition. Such images and/or graphical depictions may, for example, be product drawings, construction drawings, circuit diagrams, exploded drawings or comparable images or graphical depictions.

Automation engineering data are, for example, data as are created and/or provided for automating and/or controlling the installation or device. Such data are created, for example, in what are known as engineering systems that are used, for example, to create corresponding control programs and to accordingly parameterize the components of the installation or device and also the corresponding control operations. One example of such an engineering system is, for example, the commercially available software with the product name “TIA portal”.

In this case, automation engineering data may comprise a wide variety of engineering elements, such as one or more control programs, variables, what are known as “tags”, program modules, function modules, data modules, program blocks, what are known as “program organizational units” (POU), used data types, ID information regarding components, configuration data, call information for program elements, comments, control programs and/or comparable engineering elements.

Data categories of the automation engineering data may, for example, be:
variables or what are known as tags,
program modules, function modules, data modules, program blocks, or what are known as POUs (POU: program organizational unit),
user-defined data types (for example, what are known as UDTs),
information regarding components of the device or installation,
call information for program modules or POUs,
comments, or comparable data categories.

In this case, the engineering elements from a respective data category within the automation engineering data may be accordingly collected or associated with one another, for example, in corresponding lists, databases or comparable structures. The compilation of engineering elements from a respective data category from the automation engineering data may also be created in preparation for performing the method according to the present disclosure. Such compilation of engineering elements may occur, for example, in order to export the corresponding engineering elements from a corresponding automation engineering system. This compilation may, for example, occur in an automated manner or else in a partially automated manner. Such compilations may, for example, also be stored in a corresponding engineering system or a corresponding database and then be extracted from there for use in the context of a method according to the present description.

The engineering elements belonging to a respective one of the data categories may be present, for example, in the form of lists, tables and/or database structures within the automation engineering data or be made available as such by a corresponding engineering system. By way of example, engineering elements from the corresponding abovementioned data categories may be present or made available in the form of a tag or variable list, of a POU list, data type list, hardware info list, call structure and/or UDT list.

In this case, the individual engineering elements within the data categories of the automation engineering data may furthermore comprise respective meta-information regarding the respective engineering elements. Such meta-information may be for example names, comments, referencing, physical units, ID information (such as type names, serial numbers, ID numbers, function designations, and/or functionality) or other information in relation to the respective engineering elements.

Mechanical data or MCAD data may, for example, be engineering elements associated with or able to be assigned to the following data categories: piece, parts or component lists, 3D geometries, kinematic information, point cloud information, names/designations/meta-information regarding mechanical components or parts, relationship information regarding various mechanical components or parts (for example name, designation and/or number of further components connected to a particular part and, for example, also type and embodiment of such connections), image data regarding corresponding mechanical components or parts thereof.

Electrical planning data or ECAD data may, for example, be engineering elements associated with or able to be assigned to the following data categories: function descriptions, location information, reference numbers for products, piece or parts lists, schematic drawings, circuit diagrams, images, names, designations or number of inputs and/or outputs, information about dynamic behavior (for example, described by what are known as “macros”) or comparable engineering elements regarding electrical properties and/or embodiments of the device or installation.

Relationship information in accordance with the present disclosure may, for example, be parent/child relationships of program modules, program components and/or program or component entities.

Call information between different program modules, program components and/or program entities or program component entities may also be such relationship information. Relationship information may furthermore also be call and/or usage information of variables, tags or by corresponding program components.

Any type of assignment of engineering elements to further engineering elements, such as mechanical components or corresponding ID and/or image information, program elements or comparable engineering elements may also be relationship information in the context of the present description.

Such relationship information may, for example, also be taken from additional information regarding some of the engineering elements used. Additional information regarding some or groups of the engineering elements, which may also be configured in the form of metadata or meta-information regarding these engineering elements, may for example be names, superordinate function classes, collective terms, type descriptions, units, physical units, comments, descriptions, physical units, relationship descriptions regarding other data, functionalities, authors, authorizations, accessibility to components and/or functionalities or comparable information. The association of engineering data with such properties or categories may likewise be relationship information.

Relationship information may, for example, furthermore also be taken from cross-referencing or else material flow information.

Relationship information may in this case be directed or else undirected. Directed relationship information may, for example, be symbolized by an arrow within the multigraph, which may symbolize for example relationship information such as “is called by”, “belongs to” or similar relationships. Undirected relationship information may, for example, correspond to information that two different items of data belong to one and the same data category or are associated with the same component.

This may, for example, be taken into consideration when generating the multigraph.

The relationship information may, for example, be identified by evaluating for example call information and/or call chains of program modules, function modules, data modules or generally POUs in accordance with the present disclosure. By way of example, functional relationships between different clusters, which contain various ones of the abovementioned modules, may thereby be identified.

Relationship information may furthermore, for example, be ascertained based on meta-information regarding particular automation engineering data or else comments regarding such data. Such meta-information or comments may, for example, correspond directly to such relationship information, such as a functional association, a structural association and/or a spatial association. Relationship information may furthermore also be ascertained, for example, from names or ID information, such as from the matching of parts of names of different data elements from the same category.

A graph is a mathematical structure formed from what are known as “nodes” and what are known as “edges” connecting two respective nodes. A graphical depiction of such graphs may, for example, be a depiction in which the nodes are depicted as points or circles and the edges are depicted as respective lines connecting circles.

A multigraph is in this case understood to mean graphs in which two nodes may be connected via multiple edges.

Edges may in this case, for example, be what are known as “undirected edges”, in which the connection of the respective nodes has no associated logical direction. Edges may furthermore also be in the form of what are known as “directed edges”, in which the connection of the respective nodes has an associated logical direction.

The multigraph may, for example, be arranged and/or stored in a data format that is conventional in the art for graphs. A multigraph in the sense of the present invention is also understood to mean any other data structure that likewise implements or contains the information contained in a multigraph. A sub-graph may also be arranged and/or stored in any data format conventional in the art for graphs. A sub-graph in the sense of the present invention is understood to mean any data structure that implements and/or contains the information contained in the sub-graph.

A multigraph may in this case, for example, be structured in the sense of the present invention such that the nodes of such a multigraph correspond, for example, to different engineering elements, i.e., a respective node of the multigraph corresponds in each case to an engineering element of the data collection. The edges or connections within the multigraph are in this case formed by relationship information between the respective engineering elements, i.e., a respective edge or connection between two nodes of the multigraph corresponds in each case to relationship information between the engineering elements corresponding to the two nodes.

Such relationship information, able to be depicted as a corresponding connection of two nodes, may for example be call information or referencing information between software modules that are associated with the respective nodes. Furthermore, for example, a particular category designation or else a particular physical unit may be associated with a node as engineering element. In this case, connections of further engineering elements to the nodes may, for example, be associated with membership of the further engineering element to this category or else the use of the corresponding physical unit by the engineering element. Furthermore, for example, a connection of two nodes may also be associated with the information that the two engineering elements associated with the nodes, for example, belong to the same data category or have other comparable similarity properties.

In the context of constructing the multigraph, in this case, what is known as a “weighting” may be associated with an edge or the corresponding connection of two nodes. Such a weighting may, for example, be considered to be a strength and/or relevance of the relationship corresponding to this connection between the two engineering elements associated with the nodes. In this case, connections or edges between nodes may be weighted differently, for example, depending on their category. Thus, for example, call information may be weighted to a greater extent than membership to a particular category or physical unit. Directed information may also be weighted differently from undirected relationships, for example.

By way of example, in the case of a multigraph, different connections between nodes may thus each be weighted differently, for example, depending on a category of the associated relationship information or comparable criteria. By way of example, in a first example, the weighting may thus be implemented such that relationships between a software component and a mechanical part is assessed as the most important connection in the context of a corresponding multigraph, and therefore receives the highest weighting as seen in relation to the others. In subsequent clustering, this may then, for example, preferably give rise to clusters containing engineering elements that have a relationship with a particular mechanical part. In a further example, the number of calls between software components may, for example, be assessed such that a higher number of calls corresponds to a higher weighting of a connection, associated with these calls, between the nodes associated with respective software components. This makes it possible, for example, to form clusters in which engineering elements of comparable functionality are combined or engineering elements that are associated with a particular functionality. Furthermore, for example, call information and/or referencing information may for example also be weighted to a greater extent than membership to a particular category or physical unit.

In order to associate a weighting with an edge or connection between two nodes, the weighting categories, mentioned by way of example above, may also be combined with one another as desired.

Prior to performing the clustering method, all of the relationships between two nodes may then, for example, be summed and/or combined, for example, taking into consideration their respective weightings, to form a single weighted connection between these two nodes. In order to perform the subsequent clustering, this summary connection may then, for example, be applied, for example, with its respective weighting.

As an alternative, the clustering may however also be performed without previous potential summing of multiple connections or edges between two nodes, with a situation of multiple connections between two nodes then, for example, being able to be taken into consideration in the course of the clustering.

In the course of the following description, the terms “nodes” and “engineering elements” on graphs are accordingly used synonymously in this context. Furthermore, the terms “relationship between nodes”, “relationship information between nodes”, “edge between nodes”, “relationship between engineering elements”, “relationship information between engineering elements” and comparable terms are accordingly used synonymously in relation to graphs in the course of the following description.

In this case, the selection, the setup and/or the execution of the clustering method may be configured such that, for example, clusters or sub-graphs are formed such that a cluster or sub-graph contains engineering elements that are each associated with or able to be assigned to a particular component and/or functionality of the device or installation.

In the course of applying the clustering method to the multigraph in order to ascertain at least one sub-graph, a clustering method or clustering algorithm is, for example, applied, as is known to a person skilled in the art from the prior art for such analyses, in order to analyze topologies of such multigraphs and to segment them into one or more sub-graphs based on this analysis. Such a sub-graph may then, for example, comprise engineering elements that have an above-average and/or particularly close relationship with one another. By way of example, these may be engineering elements that are associated with or are able to be assigned to, or are able to be associated with, a particular functionality of the device or installation and/or a particular component of the device or installation.

Such a sub-graph may, for example, already be referred to as a self-description data module in the sense of the present disclosure.

Clustering or a clustering method is understood to mean what is known as a “machine learning” technique, in which data or data points are grouped into what are known as “clusters”. It is possible to use, for example, a cluster analysis method, a clustering method or a clustering algorithm in a set of data or data points in order to classify each datum or each data point into a particular group. Such a group is then referred to as a “cluster”. In this case, data or data points that are in the same group (i.e., the same cluster) have similar properties and/or features, while data points in different groups have highly different properties and/or features.

In mathematical terms, clusters consist of objects that have a shorter distance (or conversely: greater similarity) to one another than to the objects of other clusters. It is possible to distinguish between corresponding clustering methods, for example, by the distance or proximity measures that are used between objects of the clusters, but also between entire clusters. Furthermore or as an alternative, it is also possible to distinguish between corresponding clustering methods by respective calculation rules for such distance measures.

In general, the clustering method applied to the multigraph may, for example, be configured in the form of a local or global method. In this case, the methods are applied in each case either globally to the whole multigraph or only locally to a sub-graph of the multigraph. Accordingly, global methods require information about the topology of the entire multigraph, while, in the case of local methods, the neighborhood of an individual node may be considered only recursively. Local methods may thus also be used to consider networks that are not completely defined a priori.

In this case, in the course of a global clustering method, what are known as top-down or what are known as bottom-up methods may furthermore be used, for example. In top-down methods, a large starting cluster is subdivided recursively into increasingly smaller sub-clusters using different criteria, while, in bottom-up methods, a large number of smaller clusters are combined successively to form larger ones until the clustering satisfies a stop criterion.

One example of a class of top-down methods are what are known as the “spectral methods”. A further group of methods that follow the top-down approach are what are known as “random walk” or “Markov chain methods”. The “maximum flow method” is also suitable, for example, for performing clustering for what are known as weighted graphs. These likewise belong to the group of top-down methods. One example of clustering methods that use a bottom-up approach is, inter alia, what is known as “modularity optimization”. A further representative is what is known as the “nearest neighbor method”, which is commonly also used in general classification problems. In order to be able to apply the “nearest neighbor method” to graphs, it is necessary to define a similarity between two nodes. Such a similarity may be implemented, for example, based on metadata present for each node, or based on the overlap of the direct neighbors of two nodes. While the abovementioned methods may all be associated with the class of global methods, there is, for example, what is known as the “CPM method” as a possible local method.

Applying the clustering method may, for example, comprise applying a clustering algorithm or else applying multiple clustering algorithms, such as successively. Such clustering algorithms may, for example, be what is known as “K-means clustering”, what is known as “mean-shift clustering”, what is known as “expectation maximization (EM) clustering using Gaussian mixture models (GMM)”, what is known as “agglomerative hierarchical clustering” and/or what is known as “density-based spatial clustering”, such as density-based spatial clustering of applications with noise (DBSCAN)”. Further examples of clustering algorithms may, for example, be the following algorithms: “Mini batch K-means”, “affinity propagation”, “mean shift”, “spectral clustering”, “Ward”, “agglomeration clustering”, “Birch”, “Gaussian mixture”.

In method step d.), in the context of the present disclosure, selecting a sub-graph from the at least one sub-graph ascertained in method step c.) is understood to mean that a sub-graph is selected from the at least one sub-graph ascertained in method step c.).

The self-description data module may, for example, be created by virtue of the sub-graph structure generated in the course of the clustering method being stored directly in the self-description data module.

Furthermore, the creation of the self-description data module may, for example, also comprise suitable arrangement and/or storage of the information contained in the sub-graph or the self-description data module may consist of a suitable arrangement of the information contained in the sub-graph.

This suitable arrangement and/or storage of the information contained in the sub-graph may, for example, be implemented within a suitable database structure in the self-description data module and/or be implemented in any suitable database format in the self-description data module. Such database formats may, for example, be what are known as relational database formats or SQL database formats or else what are known as NoSQL database formats, semantic database formats, multigraph data formats or knowledge graph data formats.

In this case, different portions of the information contained in the sub-graph may also be stored in various ones of the abovementioned formats.

The abovementioned “NoSQL database formats” (“NoSQL” meaning “Not only SQL”) are understood to mean databases with a non-relational approach. NoSQL databases in the context of the present description are understood in particular to mean document-oriented, graph-oriented, object-oriented, attribute value pair-oriented and/or column-oriented databases.

A NoSQL database in connection with the present disclosure may, for example, be configured in the form of a document-oriented database, a graph-oriented database, a knowledge graph, a distributed ACID database, a key value database, an attribute value pair-oriented database, a multi-value database, an object-oriented database and/or in the form of a column-oriented database or a combination or development of such databases.

In the self-description data module, the information or portions of the information may be stored in the form of a relational database or the self-description data module may comprise such a database. Furthermore, in the self-description data module, the information or portions of the information may also be stored in the form of a NoSQL database, one or more knowledge graphs, a non-relational database, an OWL database, an RDF database and/or a database using SPARQL as consultation query or the self-description data module may comprise one or more such databases.

The self-description data module may furthermore be created such that program modules and/or data modules contained, for example, therein are stored in the self-description data module such that they can be integrated directly in the corresponding engineering project in the course of subsequent engineering for another device or installation. In this case, meta-information associated with these program modules and/or data modules may furthermore be stored in the self-description data module such that it is also accordingly integrated or able to be integrated in the engineering project in the course of subsequent engineering for the other device or installation. It is thereby possible, for example, to construct a module library for an engineering system consisting of such self-description data modules or to construct a module library that comprises such self-description data modules. Using such a library makes it possible to simplify the engineering of the automation of further devices or installations, because experience from past projects can thereby be accessed.

The self-description data module may furthermore comprise corresponding software elements or modules such that these are stored at least partially in the form of directly executable software in the self-description data module. In this case, these software elements or modules may, for example, be stored in the form of executable software such that they can be integrated directly into a control program for a corresponding control unit for an installation or device or else form a stand-alone control program for the installation or device. It is thereby possible to generate self-description data modules that allow particular functionalities or program elements to be incorporated directly into corresponding control programs or control units for the device or installation by way of the directly executable software elements.

In one advantageous embodiment, the method may, for example, furthermore be configured such that, in the course of method step e.), a content description file is generated, containing at least one description element for the functionality and/or component to which the sub-graph data stored in the self-description data module relate.

In this case, the wording whereby the content description file is generated in the course of method step e.) is understood to mean that the content description file is generated in the course of the creation of the self-description data module or else only after the self-description data module has already been generated.

The content description file may in this case be stored in the self-description data module or else separately therefrom. Such a content description file easily makes it possible to obtain an overview of the sub-graph data contained in the self-description data module or a component and/or functionality with which these sub-graph data are associated. This content description file may, for example, also be transferred or output to other components. By way of example, description information contained in the content description file regarding a particular functionality and/or component relating to the self-description data module may then furthermore be taken as a basis for triggering, for example, a call, an output, an execution and/or a corresponding action in relation to the functionality or component characterized by the self-description information.

The content description file may be configured, for example, in the form of a table and/or list. The content description file may furthermore also be configured in the form of a database structure in accordance with the present disclosure.

The content description file may, for example, be created in an automated manner or in a partially automated manner, wherein, in this connection, designations and/or meta-information associated with the respective engineering elements may, for example, be used in order to generate therefrom one or more description elements within the content description file that are characteristic of the engineering element.

In the case of engineering elements that comprise, for example, executable software code for generating a particular functionality, an associated description element may, for example, comprise one or more terms characteristic of the functionality. Furthermore, in this case, parameter information in relation to input parameters required to execute the functionality may also be part of the content description file and/or of a corresponding description element.

A description element for a particular engineering element may, for example, be ascertained in an automated manner. This ascertainment may also occur in a partially automated manner by, for example, offering a user a selection of various ones of the designations and/or meta-information elements associated with the engineering element, for example, on a screen. Following a corresponding selection by the user, the selected element is then associated with the content description file.

Such description information for the self-description data module may in this case be information that describes or characterizes data contained in the self-description data module, such as the engineering elements contained therein. Furthermore, such description information may also be names, identifiers and/or descriptive information that characterizes the functionality and/or component to which the self-description data module relates. Furthermore, description information, in particular for a functionality, may also be indications about, for example, parameters required to execute the functionality and/or corresponding parameter ranges. Information about, for example, boundary conditions for performing a functionality (for example, in relation to materials, and/or maximum or minimum size ratios) may also be such description information.

The self-description data module may in this case be configured such that, when a description element associated with a particular engineering element is input, the associated engineering element is called, output, executed and/or the like.

A method in accordance with the present disclosure may furthermore be configured such that the self-description data module created in the course of method step e.) is configured as a skill data module in relation to a functionality of the device or installation.

In this case, the self-description data module may, for example, be generated in the form of a skill data module such that the self-description data module is generated directly in the form of a skill data module or else that the skill data module is generated in a separate working step after a corresponding self-description data module has already been constructed. The self-description data module may furthermore also be generated first and then converted into a skill data module.

A self-description data module that is characteristic at least inter alia of a functionality of a device or installation may be referred to quite generally for example as what is known as a “skill”. Such “skills” are understood inter alia to mean data modules and/or functional modules that comprise information and/or software elements required to execute a particular functionality within a device or installation, in particular all of the information and software elements required to execute the functionality.

Such a self-description data module, designed and configured in the form of a skill, is also referred to as “skill data module” in the course of the present description and the claims.

For such a skill data module, a corresponding content description file may then comprise a skill designation and/or skill description and/or information and parameters required to execute the skill.

The skill data module may furthermore comprise software elements required to execute the associated functionality (in particular, all software elements required to execute the functionality). Such software elements may, for example, be stored in the form of program code within the skill data module. Such software elements may in particular be stored in the form of executable program code within the skill data module. The skill data module may furthermore be configured such that it is configured to control the functionality within the device or installation when the skill data module is suitably implemented and/or stored within the device or installation.

A device or installation in which such a skill data module is implemented may then, for example, communicate the corresponding skill description to external devices. These may then, for example, call this skill with the corresponding parameters, following which the associated functionality is then triggered and/or executed through the execution of software elements contained in the self-description data module.

A method in accordance with the present disclosure may furthermore comprise f.) identifying description information in relation to the engineering elements associated with the ascertained self-description data module within the data collection and within the first, second and/or third data source and storing the identified description information in the self-description data module. In this case, method step f.) may preferably be executed after method step e.), in particular executed directly after method step e.).

The identification of description information within the first, second and/or third data source is in this case configured such that, in the process, a search is performed only in those of the data sources that are actually also present in the course of performing the method.

In this case, the identification of the description information may be configured such that description information that has been identified in relation to a particular engineering element is stored in the self-description data module. If no description information has been identified in relation to an engineering element, no description information is stored in the self-description data module in relation to this engineering element either.

Description information in relation to engineering elements (such as in relation to function modules, electrical elements, wiring diagrams, and/or wiring connections) may for example be key words, comments, designations, titles, descriptions, manuals, information from manuals, ID information (such as identity numbers, order numbers, and/or brand names) or comparable information describing and/or characterizing the respective engineering elements.

Such description information may, for example, be ascertained by searching, for example, for corresponding description information within meta-information in relation to the respective engineering elements. Furthermore, in the context of designations, titles or ID information already ascertained in this way, there may then be a search for further information in relation to the corresponding engineering element in the data sources that are used.

Optical pattern recognition and/or optical character recognition may additionally also, for example, be used to take description information from images and/or graphical depictions. Such images and/or graphical depictions may for example be product drawings, construction drawings, circuit diagrams, exploded drawings or comparable images or graphical depictions.

A method in accordance with the present disclosure may furthermore comprise g.) identifying context information in relation to the engineering elements associated with the ascertained self-description data module within further data sources and storing the identified context information in the self-description data module. In this case, method step g.) may preferably be executed after method step e.) or f.) or else after further method steps following method step e.) or f.). Method step g.) may furthermore also run in parallel with the execution of method step e.) or f.).

In one advantageous embodiment of the invention, the identified context information may then furthermore be stored in the self-description data module.

In this case, context information in relation to a self-description data module is understood to mean information that relates to engineering elements and/or at least one functionality or component of the self-description data module. Such context information may be, for example, descriptive information, origin information, function descriptions, manuals, drawings, CAD data, 3D data, parts lists and/or comparable information.

In this case, the identification of the context information may be configured such that context information that has been identified in relation to a particular engineering element is stored in the self-description data module. If no context information has been identified in relation to an engineering element, then no context information is stored in the self-description data module in relation to this engineering element either.

Further data sources may, for example, be a wide variety of data sources that are linked to at least one of the engineering elements associated with the self-description data module and/or comprise information in relation to this at least one engineering element. Such further data sources may, for example, be databases, development systems, programming manuals, programming guidelines, international standards (for example, International Electrotechnical Commission (IEC) standard 61131), process descriptions, process steps, norms and/or similar data sources.

In the course of identifying the context information, context information created using optical pattern recognition and/or optical character recognition may also for example be taken from images and/or graphical depictions stored in the further data sources. Such images and/or graphical depictions may for example be product drawings, construction drawings, circuit diagrams, exploded drawings, process flow diagrams or comparable images or graphical depictions.

In one advantageous embodiment of the invention, context information taken from the further data sources may be compared with the information originally stored in the self-description data module. This comparison may, for example, concern the description information associated with particular engineering elements or else relationship information between engineering elements. It is thereby possible, for example, to ascertain indications as to whether the information stored in the self-description data module corresponds for example to relevant standards or guidelines or even process descriptions.

In the context of this advantageous embodiment, corresponding information may then be output to a user after ascertaining such indications.

In this case, the identified description information and/or the identified context information may advantageously be stored in the self-description data module in the form of a semantic database.

Storing the identified description information and/or the identified context information in the self-description data module results in an advantageous self-description data module that then forms a data module that contains, for example, a set in relation to one or more functionalities comprising, for example, corresponding engineering elements including descriptions of their functions, their usage possibilities and further descriptive data.

This gives rise, for example, to an encapsulated data module in which the wide variety of information from the wide variety of engineering sources is combined to give one or more functionalities of a device or installation or one or more components of a device or installation, preferably also including information about possible relationships between the stored information.

Using a semantic database format to store the information in this case enables both storage and retrieval of stored information in a particularly efficient manner. This is particularly the case when a multiplicity of different data types and relationships between engineering data are stored in the self-description data module. Storing such a multiplicity of data types in this way in a “normal” relational database may be highly complex and memory-intensive, and potentially even impossible.

A semantic database may, for example, be a database in which the stored information can be ascertained by way of semantic search operations. In this case, the semantic database may, for example, be present in what is known as a NoSQL database format or else what is known as the knowledge graph data format. In this case, different parts of the semantic database may also be stored in various ones of the abovementioned formats. The semantic database may furthermore also comprise further parts that are not present in any of the abovementioned database formats.

A NoSQL database may be configured in accordance with the present disclosure. The NoSQL database may, for example, be configured in the form of a document-oriented database, a graph-oriented database, a knowledge graph, a distributed ACID database, a key value database, an attribute value pair-oriented database, a multi-value database, an object-oriented database and/or in the form of a column-oriented database or a combination or development of such databases.

In the semantic database, the stored information or portions of the stored information may also be stored in the form of a NoSQL database, one or more knowledge graphs, a non-relational database, an OWL database, an RDF database and/or a database using SPARQL as consultation query or the semantic database may comprise such databases.

A method according to the present disclosure may furthermore be configured such that the self-description data module is stored in a storage unit of the device or installation, and/or that the self-description data module is stored in an engineering system for mechanical, electrical and/or automation engineering.

An automation engineering system may, for example, be configured in the form of a computer system having suitable software that is configured to generate automation engineering data for a particular machine or production installation. Such automation engineering data are, for example, data as are created and/or provided for automating and/or controlling the production installation or machine. This includes, for example, the fact that corresponding control programs are created via such an automation engineering system and the components of the production installation or machine and also the corresponding control operations are parameterized accordingly. One example of such an engineering system is, for example, a computer system on which the commercially available software having the product name “TIA portal” is installed.

The self-description data module may be stored in the engineering system, for example, in a memory of a computer or a control unit that is part of the engineering system or on which the engineering system or else parts thereof are installed and/or implemented.

It is also an object of the invention to provide a self-description data module that has been created using a method in accordance with the presently disclosed embodiments.

It is another object of the invention to provide a computer-readable storage medium comprising a self-description data module in accordance with the present disclosure.

It is also an object of the invention to provide a device or installation having a storage unit that comprises a self-description data module in accordance with the presently disclosed embodiments.

A device or installation configured in this way is capable, with reduced additional outlay, of communicating information about its functionalities and/or components to external units, such as other devices, installations, computers and/or corresponding input and/or output units. This may, for example, allow such external units to access such information and/or functionalities in a targeted manner and thus, for example, to use the device or installation or at least one of its functionalities in a simplified manner.

In one advantageous embodiment, the device or installation having the self-description data module may be designed and configured such that the self-description data module comprises a content description file in accordance with the present disclosure and/or that the device or installation is designed and configured to generate a content description file in accordance with the present disclosure.

Such a device or installation may furthermore be configured to communicate the content description file to an external unit. Such a device or installation may also be configured to receive a description element from the content description file in relation to the functionality of the device or installation and possibly thereafter to call, output corresponding information in relation to the functionality or component and/or call or execute the corresponding functionality.

This makes it possible for the device or installation to be given the ability, independently or at least in a partially automated manner, to output information in relation to its one or more functionalities and/or components to external devices, such as for example another device or installation, a webserver, an OPC server, a display unit, a management system and/or a comparable unit.

Furthermore, an activity relating to the engineering element may be triggered, for example, by selecting a particular description element characteristic of an engineering element. Thus, for example, one or more items of information associated with the engineering element may be output or else a functionality associated with the engineering element may be called or triggered.

An appropriately configured device or installation may thereby, for example, advantageously be used in the context of a modular production system, such as in the context of a cyber-physical production system (CPPS).

Furthermore, what are known as “skills” may thereby be implemented within the device or installation, these then also being communicated or able to be communicated as needed to other apparatuses, devices or installations in order for example to allow or to simplify interaction between these devices or installations in the course of production.

It is a further object of the invention to provide an automation engineering system having a storage unit, wherein the storage unit comprises a self-description data module in accordance with the present disclosure.

The automation engineering system may in this case be configured in accordance with the present disclosure.

An automation engineering system configured in this way allows simplified engineering of a further device or installation. Such engineering is simplified in particular when the further device or installation has at least some identical or similar functionalities to the device or installation in accordance with the present disclosure and/or has at least some of the same components.

In this case, when creating automation applications for the automation of the further device or installation, use may be made of engineering data already created in the past for corresponding functionalities or components. This simplifies and/or speeds up the engineering of the further device or installation.

In this case, the automation engineering system may, for example, furthermore be configured such that it comprises a content description file in relation to the self-description data module and/or is configured to generate such a content description file. The automation engineering system may then, for example, furthermore be designed such that contents of the content description file can be output, for example, to a user of the automation engineering system and, through selection of one or more description elements of the content description file that are each associated with one or more engineering elements, the associated engineering elements are able to be adopted, for example, for the engineering of the automation of the further device or installation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in more detail by way of example below with reference to the appended figures, in which:

FIG. 1 shows an exemplary illustration of a method sequence for creating engineering data in accordance with the invention;

FIG. 2 shows an exemplary setup of engineering data and relationship data in accordance with the invention; and

FIG. 3 shows an exemplary sequence of the creation of a multigraph and skill data module in accordance with the invention.

### DETAILED DESCRIPTION OF THE EXEMPLARY EMBODIMENTS

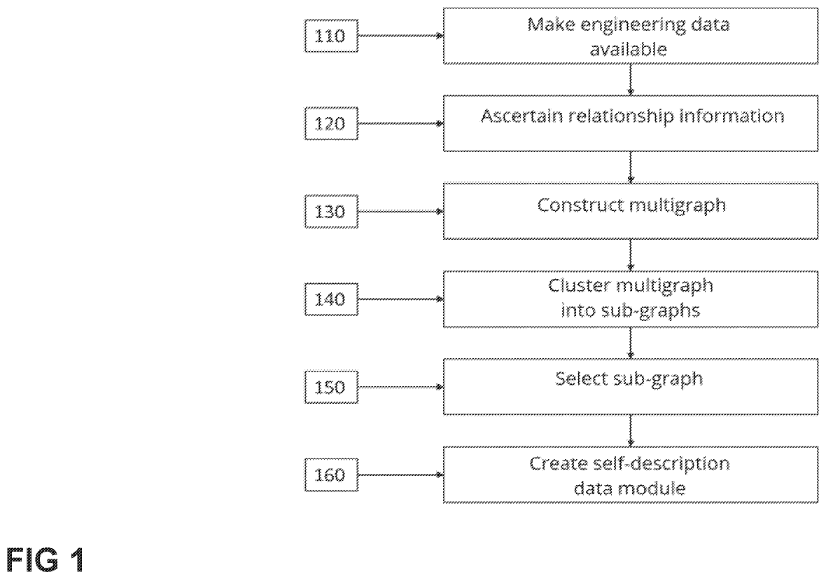

FIG. 1 schematically shows an exemplary sequence for creating a self-description data module according to the present description from corresponding engineering data.

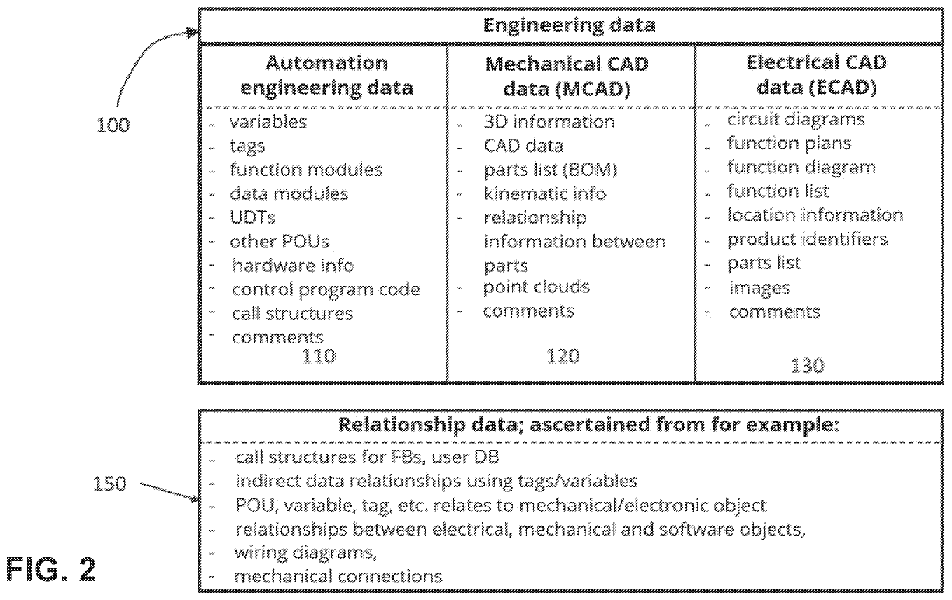

In this case, in a first step 110, engineering data 100 are made available. In this case, the engineering data 100 are one example of a data collection comprising engineering elements according to the present description. The engineering data 100 and the engineering elements contained therein are discussed in more detail in the course of the description of FIG. 2.

In a next method step 120, relationship information 150 is ascertained, in relation to these engineering data 100, between some of the engineering elements contained in the engineering data 100. The corresponding relationship information 150 and the ascertainment thereof are likewise discussed in more detail in connection with the explanations of FIG. 2.

In a following working step 130, a multigraph 200 is then created from engineering elements of the engineering data 100 and corresponding relationship information 150 regarding these engineering data 100. In this case, the selected engineering elements are selected as nodes in this multigraph 200 and the corresponding relationship information 150 is selected as connection between the respective nodes. In this case, the multigraph 200 may be created and stored in the form of a graphical depiction or else an appropriately adapted mathematical or other depiction of the multigraph structure.

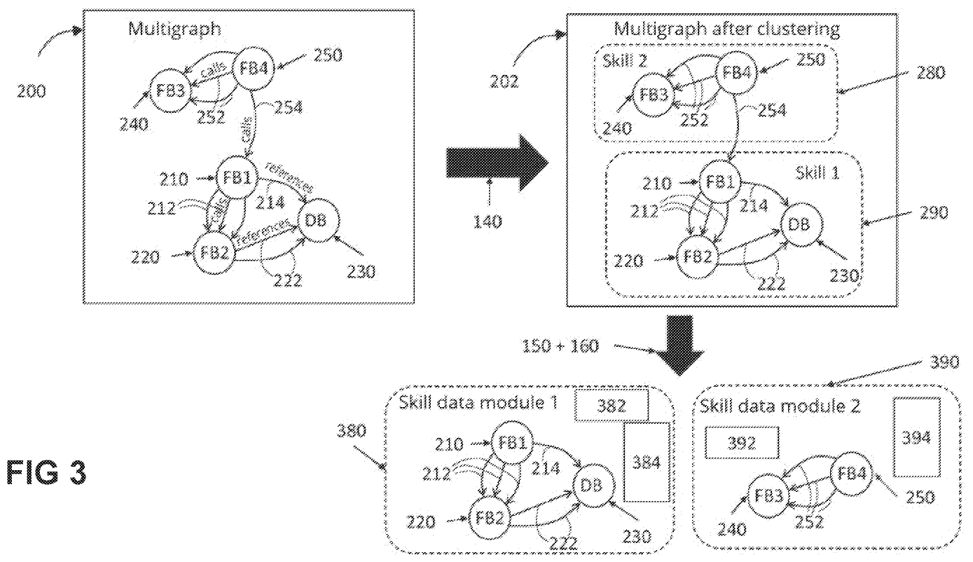

The exemplary creation of such a multigraph 200 is explained in more detail in the course of the explanations of FIG. 3.

Next, in a clustering step 140, the multigraph 200 is divided into sub-graphs 280, 290, where the clustering is configured such that the identified sub-graphs 280, 290 correspond, for example, to particular functionalities or components of an underlying installation or device. The clustering step 140 is likewise explained in more detail by way of example in the course of the explanations of FIG. 3.

Following the clustering 140, a selection step 150 then occurs, in which one of the sub-graphs 280, 290 identified in the clustering step 140 is selected to create a corresponding self-description data module 380, 390.

In a final working step 160, the self-description data module 380, 390 is then created. Such creation of a self-description data module 380, 390 is likewise explained in more detail by way of example in relation to the explanations of FIG. 3.

FIG. 2 shows a list of engineering data 100 for a device or installation in accordance with the present disclosure. The engineering data 100 in this case comprise automation engineering data 110, mechanical CAD data (MCAD) 120 and electrical CAD data (ECAD) 130.

In this case, the automation engineering data 110 comprise data that are required or used in the course of automation of the device or installation, for example, using appropriate controllers or a programmable logic controller. Such data are for example, a variable list and/or what is known as a “tag” list of the variables or tags used in the course of the control of the device or installation within such a control operation. A “tag” in the context of automation engineering is understood to mean for example a variable that is marked for display or input in an operate and observe system (SCADA system) or a graphical user interface (HMI: human machine interface).

The automation engineering data 110 furthermore comprise function modules, data modules and further what are known as “program organizational units” (POU) used in the course of controlling the device or installation or else the code of a corresponding control program for controlling the device or installation using an appropriate controller or an appropriate programmable logic controller.

The automation engineering data 110 also comprise a list of user-defined data formats (what are known as “UDTs” (user-defined type)) that were created or set up in the course of creating the automation engineering data 110.

The automation engineering data 110 furthermore comprise a list of information in relation to hardware components used in the device or installation. This information may comprise, for example, component names, component ID information (for example, serial numbers, and/or order numbers), component type designations, component description information, a list of respectively used parameters and/or corresponding parameter limit values, geometric information regarding corresponding hardware components and/or additional, background or support information regarding the corresponding hardware components.

Call structures for function modules, data modules and/or further POUs are also part of the automation engineering data 110. Such structures represent which of the modules call and/or reference which other modules. In this case, for example, chained structures, what are known as call chains, or else tree structures may, for example, arise.

The mechanical CAD data (MCA data) 120 comprise a parts list of the components of the device or installation, 3D information regarding the components of the device or installation and regarding the device or installation itself. The MCAD data 120 furthermore comprise kinematic information in relation to individual components of the device or installation, of the device or installation as a whole and between various ones of the components of the device or installation. The MCAD data furthermore also comprise points cloud information in relation to individual components of the device or installation and the device or installation as a whole.

Relationship information between parts of the device or installation is also part of the MCAD data 120. Such relationship information may, for example, be information about which components of the device or installation adjoin or are connected to which other components. The type of connection of two components may also be part of the relationship information. In this case, the connection of two components may, for example, be a spatial or mechanical connection or else a functional connection.

The electrical CAD data (ECAD data) 130 comprise circuit diagrams of the device or installation and its components, function plans thereof, function diagrams, function lists, location information in relation to electrical modules and components of the device or installation and of the device or the installation as a whole. The ECAD data 130 furthermore comprise a parts list of electrical and electronic components used, a corresponding product identifier list and images of such components and corresponding circuits in which, for example, these components are used.

In this case, the abovementioned examples of automation engineering data 110, MCAD data 120 and ECAD data 130 are examples of engineering elements in accordance with the present disclosure.

FIG. 2 furthermore shows a data collection of relationship data 150 that are examples of relationship information according to the present description. The relationship data in this case contain relationships between different function modules and/or data modules that may be derived or have been derived, for example, from the abovementioned call structures for such modules. The relationship data 150 furthermore comprise information about the relationship between various data, which may be obtained, for example, from information in relation to tags or variables.

The relationship data 150 furthermore comprise information about which program modules, function modules, data modules or generally what are known as “POUs” are associated with which components and/or parts of the device or installation. Such information may be obtained, for example, from comments or other meta-information regarding the abovementioned components. Relationships between electrical, mechanical and software objects are also part of the relationship data 150. Such relationships may be obtained, for example, from 3D information or CAD data, comments, parts lists and further meta-information. It is also possible to determine for example information about mechanical connections between various components and/or parts of the device or installation, which are also part of the relationship data 150, from these data sources.

Information obtained from wiring diagrams in relation to, for example, electrical, communication or data connections between various electrical or electromechanical components is also part of the relationship data 150.

FIG. 3 shows one exemplary example of the sequence of the generation of two skill data modules 380, 390 proceeding from a multigraph 200. For the sake of clarity, only a section of an entire multigraph is illustrated for this illustration, this being able to be created based on the engineering data 100 explained in FIG. 2.

The multigraph 200 illustrated in FIG. 3 is based on a few function modules 210, 220, 240, 250 and a data module 230 from the automation engineering data 110 according to FIG. 2. The relationship information used to construct the exemplary multigraph 200 was taken from call structures for function modules and user information for data modules from the relationship data 150 (see FIG. 2).

The multigraph 200 illustrated at the top left in FIG. 3 is one example of a result of the first three method steps 110, 120, 130 according to FIG. 1.

In this case, the multigraph has been constructed such that nodes of the multigraph 200 have been assigned to the four function modules 210, 220, 240, 250 that are denoted “FB1”, “FB2”, “FB3”, “FB4” in FIG. 3. A node in the multigraph 200 has also been assigned to the data module 230.

It may also be gleaned from the call structures for function modules within the relationship data 150 that the function module “FB1” 210 calls the second function module “FB2” 220 three times in the course of its execution. This is implemented in the multigraph 200 such that a directed connection 212 to the second function module 220 is set up three times by the first function module 210, the category “calls” furthermore being assigned to these connections 212.

Furthermore, the data module 230 is referenced once by the first function module 210, this being illustrated by a directed connection 214 between these two nodes 210, 230 in the multigraph 200. This connection 214 is assigned the property “references”. The second function module 220 also references the data module 230, where the second function module 220 references the data module 230 twice in the course of its execution. This is implemented by two directed connections 222 between the second function module 220 and the data module 230 in the multigraph 200.

It is correspondingly indicated in the multigraph 200 that the fourth function module “FB4” 250 calls the first function module “FB1” 210 by virtue of a correspondingly directed connection 254 being indicated between the corresponding nodes 250, 210 with the category “calls”. In the same way, the multigraph 200 indicates that, in the course of the execution of the fourth function module “FB4” 250, the third function module “FB3” 240 is called three times, which again is implemented in the form of three parallel-directed connections 252 between the corresponding nodes 240, 250 in the multigraph 200. These directed connections 252 are accordingly again assigned the category “calls”.

In the case of the connections 212, 214, 222, 252, 254 between the respective nodes 210, 220, 230, 240, 350 in the multigraph 200 illustrated in FIG. 3, not all of the connections are always provided with the corresponding reference sign for the sake of clarity.

The upper right-hand part of FIG. 3 illustrates a clustered multigraph 202 that results from the multigraph 200 illustrated in the top left after executing a clustering step 140 (see FIG. 1; symbolized in FIG. 3 by an arrow 140) in accordance with the present disclosure. In the present case, the clustering was, for example, configured such that a logical or resulting connection between two nodes of the multigraph 200 was weighted to a greater extent the more connections there are between these two nodes. As already previously mentioned in the context of the present disclosure at another point, in such a clustering procedure, this preferably gives rise to clusters that may be associated in particular with specific functionalities of a device or installation.

The clustering step 140, which is symbolized in FIG. 3 by an arrow 140 between the multigraph 200 and the clustered multigraph 202, was used to identify, in the clustered multigraph 202, two clusters 280, 290, which are identified “skill 1” 290 and “skill 2” 280 and by correspondingly dashed frames in FIG. 3.

FIG. 3 furthermore illustrates, at the bottom right, two skill data modules 380, 390, where each of the skill data modules 380, 390 is the respective result of applying the last two method steps 150, 160 according to FIG. 1. This is symbolized by an arrow denoted “150+160” in FIG. 3. In this case, in the course of these two method steps 150, 160, one of the sub-graphs 280, 290 of the clustered multigraph 202 is selected in each case (method step “select sub-graph” 150) and the corresponding skill data module 380, 390 is generated therefrom (method step “create self-description data module” 160), which is one example of a self-description data module in accordance with the present disclosure.

In the course of generating the first skill data module 380 from the first cluster 290, denoted “skill 1”, a skill description file 382 for the first skill data module 380 was generated. This skill description 382 contains a description of a functionality that is associated with the first skill data module 380. Such a skill description may, for example, be generated in an automated manner or else in a partially automated manner. This may be performed, for example, by evaluating comments, descriptions or further meta-information regarding the function and data modules 210, 220, 230 and/or regarding the corresponding relationship information 212, 214, 222 in the first skill data module 380.

In this case, this meta-information is sought through, for example, for terms, descriptions and/or references that may be associated, for example, with a particular functionality and/or a particular component.

A skill description 382 for the first skill data module 380 may then, for example, be generated automatically from such matching description or meta-information. Furthermore, in an alternative partially automated mode, corresponding suggestions for such a skill description 382 may be output to a user. The user may then subsequently, for example, select one of the suggestions, following which an appropriate skill description 382 is then generated. A user may furthermore also generate the skill description 382 manually.

The first skill data module 380 furthermore comprises an additional information file 384 in relation to the engineering elements 210, 220, 230 contained in the first skill data module 380 and in relation to the relationship information 212, 214, 222 associated therewith. Such information may, for example, be taken from descriptions, comments, instructions or comparable meta-information or meta-information sources regarding the correspondingly mentioned elements. The additional information file 384 may, for example, be configured in the form of a database in accordance with the present description. Both the skill description file 382 and the additional information file 384 of the first skill data module 380 may in this case be part of a content description file in accordance with the present description or form such a content description file.

In a comparable manner, a corresponding skill description file 392 and a corresponding additional information file 394 are likewise associated with the second skill data module 390. Said files may in this case, for example, be generated in the same way as the abovementioned description in relation to the skill description file 382 and the additional information file 384 of the first skill data module 380. The skill description file 392 and/or the additional information file 394 may also be part of a content description file in accordance with the present disclosure or each or together form same.

In this case, for example, the skill description files 382, 392 may comprise a unique identifier for the respective skill data module 380, 390, on the basis of which, for example, a skill data module 380, 390 may be called and/or selected. Thus, for example, in the case in which a skill data module is generally configured as executable program code and/or comprises such executable program code, this program code may be called based on a unique identifier associated with this skill data module and/or execution of this program code may be triggered. Furthermore, an appropriate skill data module with which this identifier is associated may be called from a database and, for example, loaded into an engineering project based on the unique identifier.

Such skill description files, such as the skill description files 382, 392 illustrated in FIG. 3, may furthermore comprise parameters and/or parameter descriptions that are required, for example, to execute a functionality associated with the corresponding skill data module. Such parameter descriptions and/or parameters may, for example, furthermore comprise physical units of such parameters and/or parameter limit values for the corresponding parameters. A skill data module configured in the form of executable program code may thus, for example, furthermore be called by transferring the associated unique identifier and the parameters required for the execution.

Based on the additional information files 384, 394, a user of the corresponding skill data module 380, 390 may, for example, be given access to further information regarding the engineering elements contained in the respective skill data module 380, 390. Such additional information may, for example, be used to integrate a corresponding skill data module into a corresponding engineering project as easily as possible or else to modify, to amend or to adapt a corresponding skill data module.

The skill data modules 380, 390 generated in the example illustrated in FIG. 3 may then, for example, be stored in a storage unit of a device or installation associated with the associated engineering data 100. The skill data modules 380, 390 may furthermore also be stored in a storage unit of an engineering system or a corresponding database, in order, for example, to then be used when creating a new engineering project or automation program for a further device or installation. In this case, use may occur, for example, directly in the stored version or else the respective skill data module 380, 390 may be adapted prior to integration into a new automation project or automation program.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for generating a respective self-description data module in each case in relation to at least one of (i) at least one functionality and (ii) at least one component of a device or installation, a data collection comprising engineering elements from at least one of three data sources, a first data source containing automation engineering data in relation to at least one of automation and an automation plan of the installation or device or parts thereof, a second data source containing mechanical computer aided design data in relation to a mechanical and/or spatial plan of the device or installation or parts thereof, and/or in relation to a mechanical and/or spatial design of the device or installation or parts thereof, and a third data source containing electrical computer aided design data in relation to an electrical plan and/or circuit diagram of the device or installation or parts thereof, and/or in relation to an electrical design and/or implemented circuit diagram of the device or installation or parts thereof, the method comprising:
a.) ascertaining relationship information respectively associated with engineering elements of the data collection;
b.) generating a multigraph comprising nodes and connections between nodes, the nodes each being associated with engineering elements of the data collection and the connections each being associated with relationship information ascertained in accordance with step a.);
c.) applying a clustering method to the multigraph to ascertain at least one sub-graph within the multigraph;
d.) selecting a sub-graph from the at least one sub-graph ascertained in step c.); and
e.) creating a self-description data module in relation to a component and/or a functionality of the device or installation, the self-description data module comprising the selected sub-graph and/or information contained in the sub-graph.

14. The method as claimed in claim 13, wherein during step e.), a content description file is generated, containing at least one description element for at least one of a functionality and component to which the sub-graph data stored in the self-description data module relate.

15. The method as claimed in claim 13, wherein the self-description data module generated in during step e.) is configured as a skill data module in relation to a functionality of the device or installation.

16. The method as claimed in claim 14, wherein the self-description data module generated in during step e.) is configured as a skill data module in relation to a functionality of the device or installation.

17. The method as claimed in claim 13, further comprising:
f.) identifying description information in relation to the engineering elements associated with the ascertained self-description data module within the data collection and within at least one of the first, second and third data sources, and storing the identified description information in the self-description data module.

18. The method as claimed in claim 13, further comprising:
g.) identifying context information in relation to the engineering elements associated with the ascertained self-description data module within further data sources and storing the identified context information in the self-description data module.

19. The method as claimed in claim 17, wherein at least one of the identified description information and the identified context information are stored in the self-description data module as a semantic database.

20. The method as claimed in claim 18, wherein at least one of the identified description information and the identified context information are stored in the self-description data module as a semantic database.

21. The method as claimed in claim 13, wherein the self-description data module is stored in at least one of (i) a storage unit of the device or installation, (ii) an engineering system for at least one of mechanical, electrical and automation engineering.

22. A self-description data module for a device or installation, wherein the self-description data module is created via the method as claimed in claim 13.

23. A non-transitory computer-readable storage medium comprising the self-description data module as claimed in claim 22.

24. A device or installation having a storage unit, wherein the storage unit comprises the self-description data module as claimed in claim 22.

25. The device or installation as claimed in claim 24, wherein at least one of:
(i) the self-description data module comprises a generated content description file containing at least one description element for at least one of a functionality and component to which the sub-graph data stored in the self-description data module relate and
(ii) the device or installation is configured to generate the generated content description file containing at least one description element for at least one of a functionality and component to which the sub-graph data stored in the self-description data module relate;
wherein at least one of the device or installation is further configured to communicate the content description file to an external device and the device or installation is further configured to receive a description element from the content description file in relation to the functionality of the device or installation and to then at least one of call, output corresponding information in relation to the functionality or component and call or execute the corresponding functionality.

26. An automation engineering system comprising:
a storage unit;
wherein the storage unit comprises the self-description data module as claimed in claim 22.
